(19) United States
(12) Patent Application Publication
(10) Pub. No.: US 2012/0044327 A1
(43) Pub. Date: Feb. 23, 2012

(54) DEVICE FOR ACQUIRING STEREO IMAGE

(76) Inventors: Shinichi Horita, Osaka (JP); Hironori Sumitomo, Osaka (JP); Hiroshi Yamato, Hyogo (JP)

(21) Appl. No.: 13/318,672

(22) PCT Filed: Apr. 28, 2010
(86) PCT No.: PCT/JP2010/057561

§ 371 Date: Nov. 3, 2011

(30) Foreign Application Priority Data
May 7, 2009 (JP) 2009-112607

(51) Int. Cl. H04N 13/02

(52) U.S. Cl. 348/47; 348/E13.074

(57) ABSTRACT

Disclosed is an inexpensive device for acquiring a stereo image, in which base data is generated and recorded from an image captured by a base camera according to a first frame rate, and reference data is generated and recorded from an image captured by a reference camera according to a second frame rate which is the same as the first frame rate or lower than the first frame rate, the second frame rate dynamically determined depending on the status of a vehicle or the periphery thereof during the image-capturing, and thereby the device can record a stereo image with high image quality and acquire highly accurate distance information, and can also eliminate the need for an expensive storage medium or an expensive electronic circuit.

### TECHNICAL FIELD

The present invention relates to a device for acquiring a stereo image, particularly to an on-board device for acquiring a stereo image.

### BACKGROUND ART

In the automotive industry, there is a very active effort going on in terms of how to improve safety, and the trend is moving toward introduction of an increasing number of danger avoidance systems using an image sensor of a camera or radar. One of the well-known systems includes a system that uses an image sensor or radar to get information on the distance of the vehicle from the surrounding object, thereby avoiding danger.

In the meantime, in the taxicab industry, the trend is toward introduction of drive recorders. The drive recorder is a device for recording the image before and after an accident, and is effectively used to analyze the cause of the accident. For example, the responsibility for the accident can be identified to some extent by watching the images recorded at the time of collision between vehicles.

For example, Patent document 1 discloses the technique wherein long-hour images can be recorded and the required images can be quickly reproduced since the image information is compressed and recorded in a random access recording device.

Patent document 2 discloses an operation management device in which the image of a drive recorder and others is used in the training course of the drivers. In this device, on the ocation of reproduction of the image of an accident, when the driving data has reached a risky level, the image reproduction is turned to slow reproduction for the situation of the accident to be easily recognized.

In the image pickup operation of the aforementioned devices, it would be very effective if the distance information were obtained by a stereo image. For example, Patent document 3 discloses a method for detecting a moving object within the range of surveillance by extracting a 3D object present within the range of surveillance by using a pair of images captured in a chronological order by a stereo camera, and calculating the three-dimensional motion of the 3D object. However, the object of Patent document 3 is to detect a moving object in front of the vehicle and to avoid collision with the moving object, and no reference is made to such a device for recording an image as the aforementioned drive recorder.

In the meantime, Patent document 4 introduces a vehicle black box recorder that records the image obtained by an image pick device for capturing the surroundings of the moving vehicle. In this device, if there are objects in the area of windows provided inside the image, the distance is calculated for each window by a stereoscopic measurement method and the calculated distances are displayed on the screen. The result is stored together with the image information.

### RELATED ART DOCUMENT

### Patent Document

Patent document 1: Official Gazette of Japanese Patent Laid-open No. 3254946

Patent document 2: Unexamined Japanese Patent Application Publication No. 2008-65361

Patent document 3: Unexamined Japanese Patent Application Publication No. 2006-134035

Patent document 4: Official Gazette of Japanese Patent Laid-open No. 2608996

### SUMMARY OF THE INVENTION

### Object of the Invention

In the method disclosed in Patent document 4, however, the distance must be calculated from the stereo image on a real-time basis inside the vehicle black box recorder. This requires use of a high-priced electronic circuit exemplified by a high-speed microcomputer and a memory. Further, high-precision calculation of the distance requires high-quality stereo images, and storage of all these images requires a high-priced storage medium having an enormous amount of capacity and high-speed recording capacity. Thus, such a vehicle black box recorder has to be very expensive.

In view of the problems described above, it is an object of the present invention to provide a low-priced device for acquiring a stereo image which is capable of recording high-quality stereo images and of obtaining high-precision distance information, without requiring an expensive storage medium or an electronic circuit.

### Means for Solving the Object

The object of the invention is solve by the following configuration.

Item 1. A device for acquiring a stereo image which is equipped with a camera section having at least two cameras including a base camera for taking base images of stereo images and a reference camera for taking reference images of the stereo images; a recording section configured to record image data taken by the camera section as record data; a control section configured to control the camera section and the recording section, wherein the device is configured to be mounted on a vehicle to acquire a stereo image of surroundings of the vehicle, the device comprising:
a frame rate determination section configured to determine a frame rate of the record data to be recorded in the recording section;
a base data generation section to generate base data, from the base images taken by the base camera, on the basis of a first frame rate determined by the frame rate determination section; and
a reference data generation section configured to generate reference data, from the reference images taken by the reference camera, on the basis of a second frame rate which is determined by the frame rate determination section and is equal to or lower than the first frame rate,
wherein the frame rate determination section dynamically determines the second frame rate, depending on conditions and surroundings of the vehicle when the camera section takes images; and the recording section records the base data generated by the base data generation section and the reference data generated by the reference data generation section as the record data.

Item 2. The device for acquiring a stereo image of item 1, wherein the frame rate determination section dynamically determines the second frame rate on the basis of any one of or a combination of a plurality of the following conditions:
(1) a speed of the vehicle;
(2) an operation condition of a steering wheel of the vehicle;
(3) an amount of a change in an optical flow for at least one of the cameras; and
(4) an amount of a temporal change in a parallax between the base camera and the reference camera.

Item 3. The device for acquiring a stereo image of item 1 or 2, wherein
the reference data generation section generates the reference data, in uncompressed form or after performing compression with a low compression rate, on the basis of the second frame rate, and the reference data generation section generates second reference data compressed with a compression rate higher than the compression rate for the reference data, by using the reference image which is of the reference image not used to generate the reference data and is synchronized in the first frame rate; and
the recording section records the base data, the reference data, and the second reference data as the record data.

### Advantage of the Invention

According to the present invention, the base data is produced from the image taken by the base camera on the basis of the first frame rate and is recorded; the reference data is produced from the image taken by the reference camera on the basis of the second frame rate which is equal to or lower than the first frame rate and is dynamically determined based on the vehicle and the surroundings of the vehicle at the time of image taking, whereby high quality stereo images are recorded, a high-precision distance information is obtained, and an expensive recording medium and electronic circuit are not required, thereby providing an inexpensive device for acquiring a stereo image.

### BRIEF DESCRIPTION OF THE DRAWINGS

FIG. 1 is a block diagram showing the structure of a first embodiment of a device for acquiring a stereo image;

FIG. 2 is a block diagram showing the structure of a frame rate determination section;

FIGS. 3a and 3b are block diagrams showing the structure of a data generation section;

FIG. 4 is a schematic diagram showing the process of generating base data and reference data under the normal states;

FIG. 5 is a schematic diagram showing the process of generating the base data, reference data and second reference data under the normal states;

FIG. 6 is a schematic diagram showing the process of generating the base data and reference data under the conditions that recording is needed;

FIG. 7 is a schematic diagram showing the process of generating the base data and reference data in the case that the condition changes from the normal state to the record-demanding condition and back to the normal state;

FIG. 8 is a block diagram showing the structure of a second embodiment of a device for acquiring a stereo image; and

FIG. 9 is a schematic diagram showing the process of generating the base data and reference data in a third embodiment of the device for acquiring a stereo image.

### DETAILED DESCRIPTION OF THE PREFERRED EMBODIMENTS

The following describes the present invention with reference to embodiments, without the present invention being restricted thereto. The same or equivalent portions in the drawings will be assigned the same reference numbers, and duplicated explanations will be omitted.

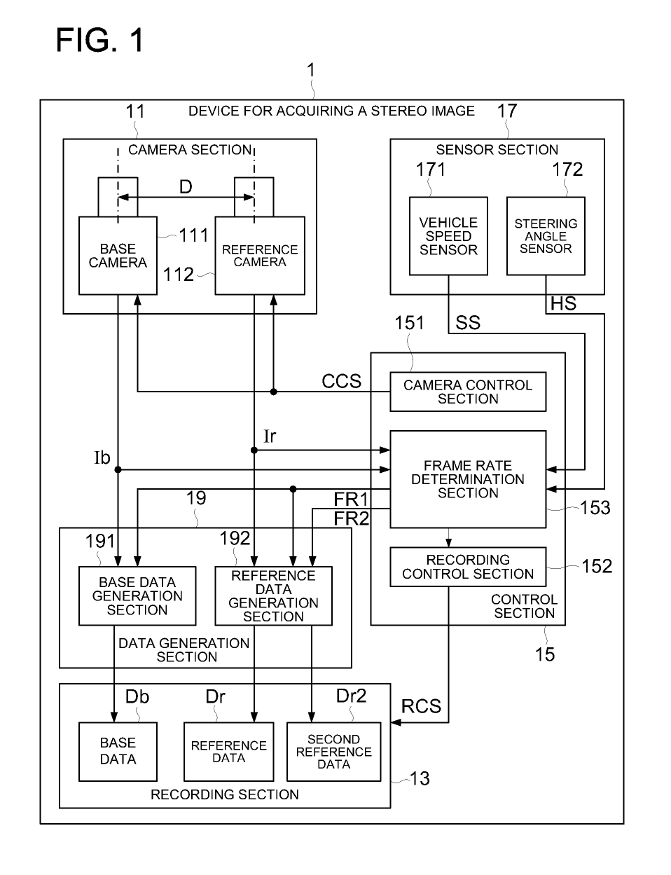

Referring to FIG. 1, the following describes the structure of the first embodiment of the device for acquiring a stereo image in the present invention. FIG. 1 is a block diagram showing the structure of the first embodiment of a device for acquiring a stereo image in the present invention.

In FIG. 1, the device for acquiring a stereo image 1 includes a camera section 11, a recording section 13, a control section 15, a sensor section 17, and a data generation section 19.

The camera section 11 includes: at least two cameras, a base camera 111 and a reference camera 112. The base camera 111 and the reference camera 112 are arranged apart from each other by a prescribed base line length D. In synchronism with a camera control signal CCS from a camera control section 151 (to be described later), base images Ib are outputted from the base camera 111 at a prescribed frame rate FRO, and a reference images Ir are outputted from the reference camera 112.

The recording section 13 includes a hard disk or a semiconductor memory. Base data Db and reference data Dr are recorded on the basis of a recording control signal RCS from a recording control section 152. A second reference data Dr2 is also recorded if required.

The control section 15 includes the camera control section 151, the recording control section 152 and a frame rate determination section 153. The components of the recording section 13 may be made of hardware, or the functions of the components may be implemented by using a microcomputer and software.

The camera control section 151 outputs the camera control signal CCS for synchronizing the image capturing operations of the base camera 111 and reference camera 112.

The recording control section 152 outputs a recording control signal RCS at the frame rate determined by the frame rate determination section 153 (to be described later), and controls the recording operation of the recording section 13.

The frame rate determination section 153 determines a first frame rate FR1 and outputs the first frame rate FR1 to the data generation section 19, and the base images Ib, which are taken by the base camera 111 at the prescribed frame rate FR0 in synchronism with the camera control signal CCS from the camera control section 151, are thinned out with respect to the first frame rate FR1 to generate and record the base data Db.

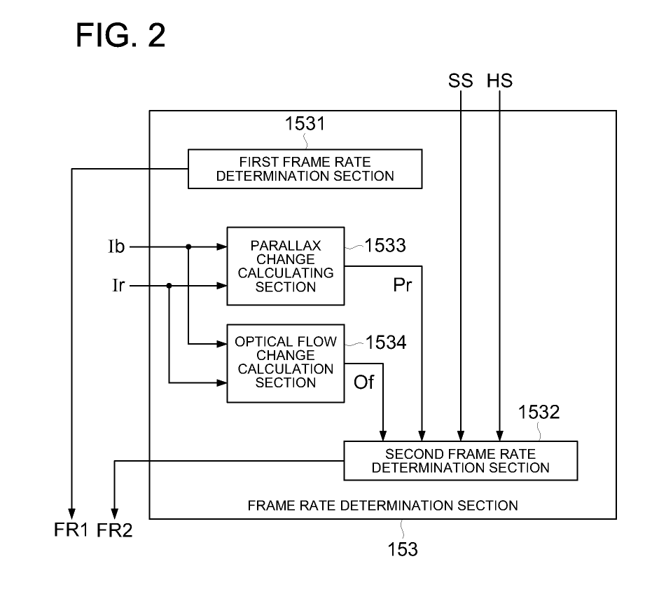

In a similar manner, the frame rate determination section 153 determines a second frame rate FR2 which is equal to or lower than the first frame rate FR1, and outputs the second frame rate FR2 to the data generation section 19, and the reference images Ir, which are taken by the reference camera 112 at the prescribed frame rate FR0 in synchronism with the camera control signal CCS from the camera control section 151, is thinned out with respect to the second frame rate FR2 to generate and record the reference data Dr. How to determine the first frame rate FR1 and the second frame rate FR2 is described in detail with reference to FIG. 2.

The sensor section 17 is constituted by a vehicle speed sensor 171 for detecting the speed of a vehicle (hereinafter referred to as “own vehicle”) which is provided with a device 1 for acquiring a stereo image, and a steering angle sensor 172 for detecting the operating conditions of the steering wheel of the own vehicle. An own vehicle speed signal SS, which is the output from the own vehicle speed sensor 171, and a steering angle signal HS, which is the output from the steering angle sensor 172, are inputted into the frame rate determination section 153, and are used for the determination of the second frame rate FR2. To detect the operating conditions of the steering wheel of the own vehicle, instead of the steering angle sensor 172, an acceleration sensor can be used to detect the acceleration perpendicular to the traveling direction of the own vehicle.

The data generation section 19 includes a base data generation section 191 and a reference data generation section 192. The components of the data generation section 19 may be made of hardware, or the functions of the components may be implemented by using a microcomputer and software.

The base data generation section 191 thins out the base images lb of the base camera 111 at the first frame rate FR1, and generates the base data Db with the image not compressed or compressed at a low compression rate. The base data Db is outputted to the recording section 13. The compression method applied at a low compression rate is preferably a lossless compression method. The base images Ib subjected to the thinning out at the first frame rate FR1 are discarded.

Similarly, the reference data generation section 192 thins out the reference images Ir of the reference camera 112 at the second frame rate FR2 and generates the reference data Dr with the image not compressed or compressed at a low compression rate. The reference data Dr is outputted to the recording section 13. The compression method applied at a low compression rate is preferably a lossless compression method. The reference image sIr subjected to the thinning out at the second frame rate FR2 are discarded or are subjected to the following processing if required.

When required, on the reference images Ir thinned out in synchronism with the first frame rate FR1 of the reference images Ir having been subjected to the thinning at the second frame rate FR2, the reference data generation section 192 performs the process of compression at a high compression rate and generates the second reference data Dr2. The second reference data Dr2 is then outputted to the recording section 13. The compression at a high compression rate can be lossy compression. The reference images Ir which have not been used to generate the reference data Dr or the second reference data Dr2 will be discarded.

Referring to FIG. 2, the following describes the method of the first embodiment for determining the first frame rate FR1 and the second frame rate FR2 in the aforementioned frame rate determination section 153. FIG. 2 is a block diagram showing the structure of the frame rate determination section 153.

In FIG. 2, the frame rate determination section 153 includes a first frame rate determination section 1531, a second frame rate determination section 1532, a parallax change calculating section 1533 and an optical flow change calculating section 1534. The components of the frame rate determination section 153 may be made of hardware or the functions of the components may be implemented by using a microcomputer and software.

The frame rate determination section 153 determines the first frame rate FR1. The first frame rate FR1 is set at a prescribed value independent of the conditions of the own vehicle and the surroundings, and is not changed even if there is a change in the conditions of the own vehicle and the surroundings. For example, when the base camera 111 captures images at a prescribed frame rate FR0=30 frames/sec. (hereinafter referred to as “fps”), the first frame rate FR1 is set at half that value, i.e., 15 fps. In this manner, one out of two frames of the base images lb captured by the base camera 111 is used to generate the base data Db. The other frames are discarded.

The second frame rate determination section 1532 determines the second frame rate FR2. The second frame rate FR2 is equal to or lower than the first frame rate FR1, and is determined depending on the conditions of the own vehicle and its surroundings. The second frame rate FR2 is dynamically changed if there is a change in the conditions of the own vehicle and the surroundings.

In FIG. 2, the own vehicle speed signal SS, which is an output from the own vehicle speed sensor 171 and indicate the current conditions of the own vehicle, and the steering angle signal HS, which is an output from the steering angle sensor 172, are inputted into the second frame rate determination section 1532.

The base images Ib and the reference images Ir are inputted into the parallax change calculating section 1533 and the change in parallax is calculated in the parallax change calculating section 1533. The parallax change signal Pr is inputted into the second frame rate determination section 1532.

Similarly, the base images Ib and the reference images Ir are inputted into the optical flow change calculating section 1534 and the shift in optical flow is calculated in the optical flow change calculating section 1534. The optical flow change signal Of is inputted into the second frame rate determination section 1532. The parallax change signal Pr and the optical flow change signal Of indicate the surroundings around the own vehicle.

The second frame rate determination section 1532 determines and dynamically changes the second frame rate FR2 based on any one or a combination of more than one of the aforementioned vehicle speed signal SS, the steering angle signal HS, the parallax change signal Pr, and the optical flow change signal Of.

The following describes the parallax change signal Pr and the optical flow change signal Of The parallax change signal Pr will be described first. The parallax is defined as a difference between the positions, of the same object, in the base image Ib and the reference image Ir. The parallax is proportional to the reciprocal umber of the distance from the subject. The greater the parallax is, the smaller the distance from the subject is. The smaller the parallax is, the greater the distance from the subject is.

Distance to the subject can be calculated from the base line lengths D of the base camera 111 and the reference camera 112, the focal distances of the pickup lenses of the base camel a 111 and the reference camera 112, and the value of the parallax.

The amount of the change in parallax can be defined as the amount of temporal change in the parallax. When the change in parallax is 0 (zero) or small, there is no change or a small change in the change in the distance from the subject. When the parallax is getting larger, the object is getting closer, and when the parallax is getting smaller, the object is getting farther.

Therefore, when the change in the parallax is 0 (zero) or is getting smaller, the object, i.e., another vehicle, a human body or an obstacle ahead is at the same distance or is getting away, which situation means that there is little possibility of collision with the object. In contrast, when the change in the parallax is increasing, the object is getting closer, which situation means that there is a risk of collision. In this manner, by using the parallax change signal Pr, the change in the distance between the own vehicle and the object is detected without calculating the distance to the object.

The following describes the optical flow change signal Of. The optical flow can be defined as the vector indicating the temporal change in the position of an object in the captured image. A 3D optical flow can be obtained by calculating the optical flow of the object ahead such as another vehicle from a stereo image, and if the extension of the 3D optical flow crosses the moving direction of the own vehicle, there is a risk of collision.

Thus, by using a 3D optical flow there can be detected not only a situation change, such as the change in the distance to the object indicated by the parallax change, in the traveling direction of the own vehicle, but also a situation change in the surroundings of the own vehicle such as a situation change like a cutting-in in the direction perpendicular to the traveling direction of the own vehicle, whereby the situation change in the surroundings of the own vehicle is more effectively detected.

Getting back to the second frame rate determination section 1532, the second frame rate determination section 1532 determines and dynamically changes the second frame rate FR2 based on any one or a combination of more than one of the aforementioned four signals; the vehicle speed signal SS, the steering angle signal HS, the parallax change signal Pr, and the optical flow change signal Of.

Here the situation of the own vehicle and the surroundings are classified into two states; a normal state CS1 and a record-demanding state CS2. The second frame rate FR2 will be determined for each of the states.

(Normal state CS1)

Vehicle speed signal SS: Moving at a constant speed or at an accelerated or decelerated speed within a prescribed range.

Steering angle signal HS: Straight moving or the steering angle is within a prescribed range.

Parallax change signal Pr: 0 (zero) or small, or the parallax is reducing.

Optical flow change signal Of: There is no risk of collision.

When the aforementioned four conditions are met, it is judged that there is little risk of collision, and the second frame rate FR2 is set low. For example, when images are captured by the base camera 111 and reference camera 112 at FRO=30 fps, and the first frame rate FR1 is 15 fps, the second frame rate FR2 is set at half that value, i.e., 7.5 fps. Thus, one out of four frames of the reference images Ir captured by the reference camera 112 is used to generate the reference data Dr.

(Record-demanding state CS2)

Vehicle speed signal SS: Accelerated or decelerated speed exceeding a prescribed range.

Steering angle signal HS: Steering angle out of a prescribed range.

Parallax change signal Pr: Parallax is increasing.

Optical flow change signal Of: There is a risk of collision.

If any one of the aforementioned conditions is met, it is judged that there is a risk of collision, and the second frame rate FR2 is set higher. For example, if images are captured by the base camera 111 and reference camera 112 at FRO=30 fps, and the first frame rate FR1 is 15 fps, the second frame rate FR2 is set at 15 fps, which is the same as the first frame rate FR1. Thus, one out of two frames of the reference images Ir captured by the reference camera 112, similarly to the case of base data Db, is used to generate the reference data Dr.

To determine the conditions of the own vehicle and the surroundings, it is preferred to use all of the four signals, the vehicle speed signal SS, the steering angle signal HS, the parallax change signal Pr and the optical flow change signal Of. However, it is also possible to use one of these four signals or a combination of a plurality of these signals. For example, the own vehicle speed signal SS alone may be used, and when the own vehicle speed signal SS indicates that the vehicle is moving at a constant speed or at an accelerated or decelerated speed within a prescribed range, the state is determined to be the normal state CS1. Instead, when the own vehicle speed signal SS indicates that the vehicle is moving at an accelerated or decelerated speed beyond the prescribed range, the state is determined as the record-demanding state CS2.

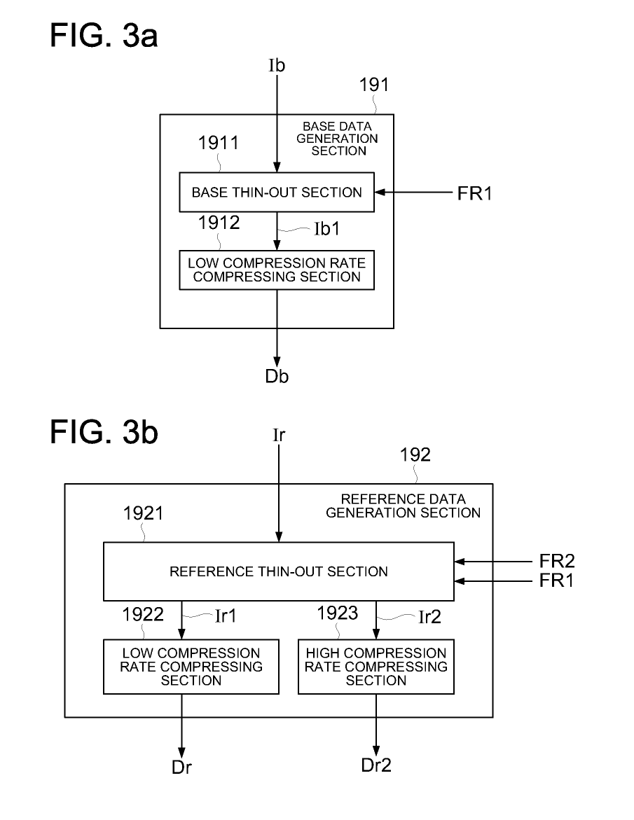

Referring to FIG. 3, the following describes the method for generating the base data Db in the base data generation section 191 of the data generation section 19, and the method for generating the reference data Dr and second reference data Dr2 in the reference data generation section 192. FIGS. 3a and 3b are block diagrams showing the structure of the data generation section 19. FIG. 3a shows the structure of the base data generation section 191, and FIG. 3b shows the structure of the reference data generation section 192.

In FIG. 3a, the base data generation section 191 is made up of a basic thin-out section 1911 and a low compression rate compressing section 1912. The components of the base data generation section 191 may be made of hardware, or the functions of the components may be implemented by using a microcomputer and software.

The base images Ib captured at a prescribed frame rate FR0 (e.g., 30 fps) by the base camera 111 are inputted into the basic thin-out section 1911. The basic thin-out section 1911 thins out the base images Ib according to the first frame rate FR1 (e.g., 15 fps) determined by the frame rate determination section 153, and generates and outputs the basic thinned-out image Ib1. The image of the frame not used to generate the basic thinned-out image Ib1 is discarded.

The basic thinned-out image Ib1 is subjected to compression of a low compression rate by the low compression rate compressing section 1912, and is outputted as the base data Db from the base data generation section 191. However, the basic thinned-out image Ib1 may be outputted as the base data Db without being compressed.

In FIG. 3b, the reference data generation section 192 is made up of a reference thin-out section 1921, a low compression rate compressing section 1922, a high compression rate compressing section 1923 and others. The components of the reference data generation section 192 may be made of hardware, or the functions of the components may be implemented by using a microcomputer and software.

The reference images Ir captured at a prescribed frame rate FR0 (e.g., 30 fps) by the reference camera 112 is inputted into the reference thin-out section 1921. The reference thin-out section 1921 thins out the reference images Ir according to the second frame rate FR2 (e.g., 7.5 fps) determined by the frame rate determination section 153, and generates and outputs the reference thinned-out images Ir1.

The reference thinned-out images Ir1 are subjected to compression of a low compression rate by the low compression rate compressing section 1922, and is outputted as the reference data Dr from the reference data generation section 192. However, the reference thinned-out images Ir1 may be outputted as the reference data Dr without being compressed.

Of the images of the frame not used to generate the reference thinned-out images Ir1, the images of the frame synchronized with the first frame rate FR1 (e.g., 15 fps) determined by the frame rate determination section 153 are inputted as the second reference thinned-out images Ir2 into the high compression rate compressing section 1923 and are subjected to compression with a high compression rate. These images are then outputted as the second reference data Dr2. The images of the frame not used to generate the reference thinned-out images Ir1 or the second reference thinned-out images Ir2 are discarded.

The step of generating the second reference data Dr2 is not essential, and can be omitted. Compression of the high compression rate in the high compression rate compressing section 1923 can be lossy compression.

As described above, by using the images of the frame synchronized with the first frame rate FR1 of the images of the frame not used to generate the reference thinned-out images Ir1, the second reference data Dr2 is generated. With this arrangement, the distance is calculated from a stereo image method in conformity to the stereo image, although the precision is not good due to a high compression rate. Thus, the precision analysis of the cause for an accident can be conducted. There is only a small increase in the amount of recording data in the second reference data Dr2 because a high compression rate is used for its compression.

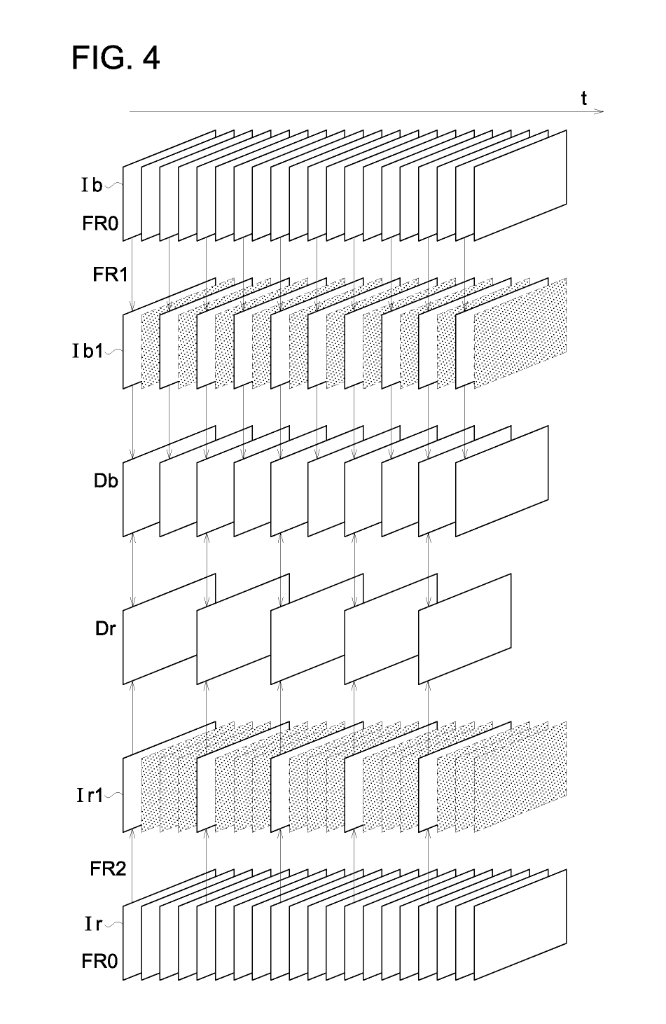

Referring to FIGS. 4 through 7 showing the process of forming an image file, the following describes the operation of the first embodiment. FIG. 4 is a schematic diagram showing the process of forming the base data Db and reference data Dr in the normal state CS1.

In FIGS. 4 through 7 and FIG. 9 (to be described later), it is assumed that images are captured in chronological order along the time axis “t” from the left to the right. In FIGS. 4 through 7 and FIG. 9, the first frame rate FR1 is set at half the prescribed frame rate FR0, and the second frame rate FR2 is set at half the first frame rate FR1 in the normal state CS1, and the value equal to the first frame rate FR1 in the record-demanding state CS2. Further, in FIGS. 4 through 7 and FIG. 9, the images drawn by the broken line have been discarded through thinning.

In FIG. 4, the base images Ib are outputted from the base camera 111 at a prescribed frame rate FR0. The base images Ib are subjected to thinning at the first frame rate FR1, and the thinned-out data is recorded in the recording section 13 as the base data Db without being compressed or after being compressed at a low compression rate.

In the meantime, the reference images Ir are outputted from the reference camera 112 at a prescribed frame rate FR0. The reference images Ir are subjected to thinning at the second frame rate FR2, and the thinned-out data is recorded in the recording section 13 as the reference data Dr without being compressed or after being compressed at a low compression rate.

Thus, in the case that both the base data Db and reference data Dr are uncompressed, the amount of the base data Db is half that of the base images Ib, and the amount of the reference data Dr is a quarter of that of the reference images Ir, and the recording capacity can be saved by that amount. It should be noted that the distance can be calculated from a stereo image between the corresponding base data Db and reference data Dr, which are indicated by two-way arrows.

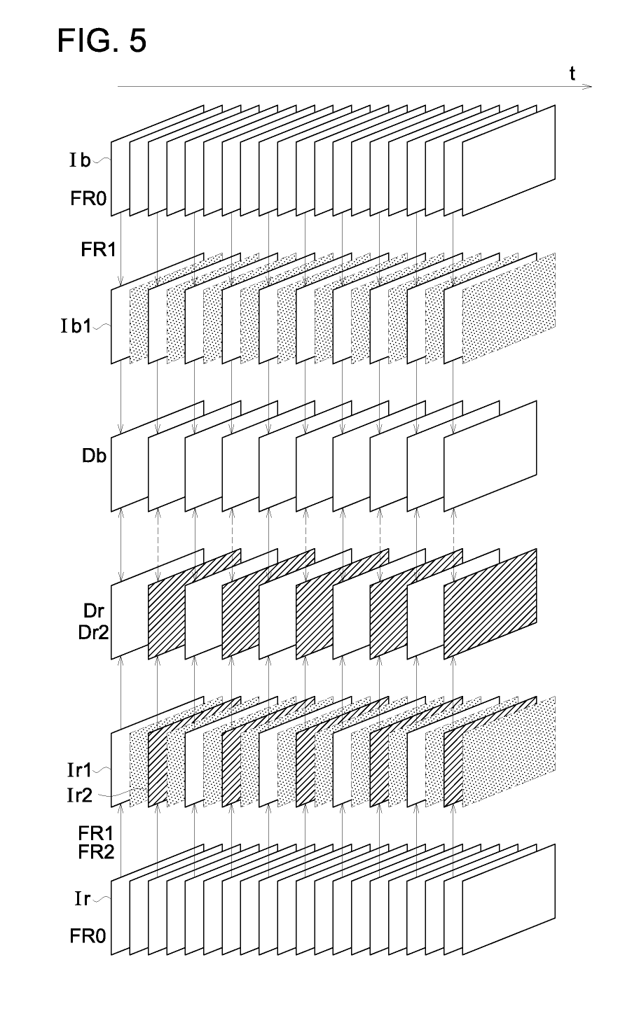

FIG. 5 is a schematic diagram showing the process of forming the base data Db and reference data Dr in the normal state CS1. The difference of FIG. 5 from FIG. 4 is that, of the images fro which images were thinned out at the second frame rate FR2, the second reference thinned-out images Ir2 captured synchronously with the first frame rate FR1 are subjected to compression of a high compression rate and is recorded in the recording section 13 as a second reference data Dr2. Otherwise, FIG. 5 is the same as FIG. 4.

Since the second reference data Dr2 is compressed at a high compression rate, there is only a smaller increase in the amount of data, when compared with example of FIG. 4. Further, calculation of the distance from a stereo image can be performed between the corresponding base data Db and second reference data Dr2, which are indicated by two-way arrows, although the precision is not good because the second reference data Dr2 is compressed at a high compression rate.

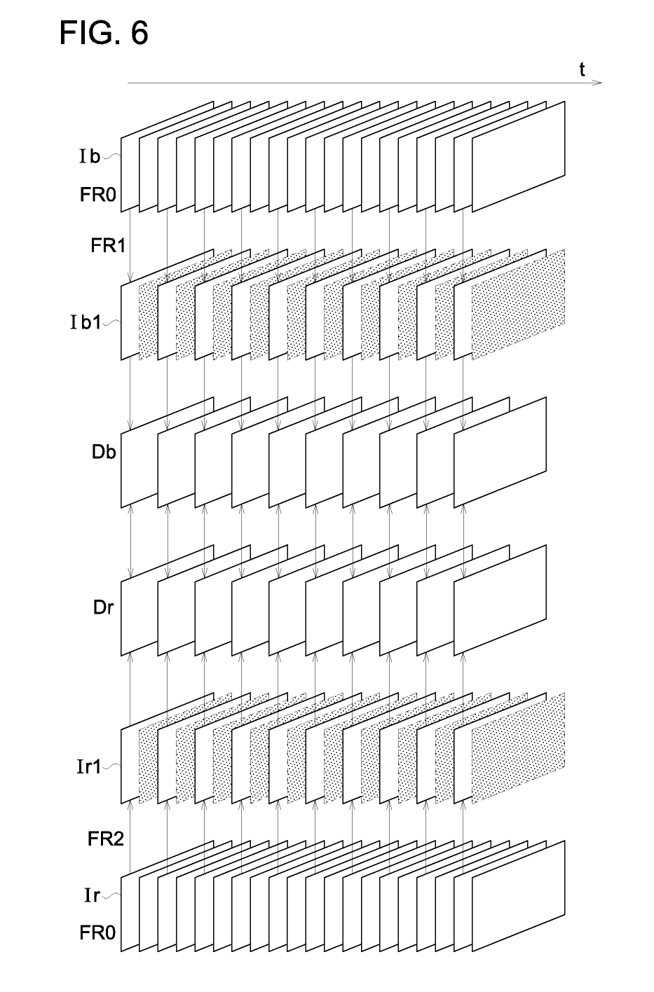

FIG. 6 is a schematic diagram showing the process of forming the base data Db and the reference data Dr in the aforementioned record-demanding state CS2. The difference of FIG. 6 from FIG. 4 is that the second frame rate FR2 used to record the reference images Ir of the reference camera 112 in the recording section 13 is the same as the first frame rate FR1, and the reference data Dr is recorded at the same density as the base data Db. Otherwise, FIG. 6 is the same as FIG. 4.

Thus, in the case that the base data Db and the reference data Dr are uncompressed, the amount of the base data Db is half that of the base images Ib, and the amount of the reference data Dr is also a half that of the reference images It As a result, the recording capacity is increased by a quarter of the amount of the reference images Ir, when compared to FIG. 4. Despite that, the capacity is reduced to half the amount of the original image. Further, the distance can be calculated from a stereo image between the corresponding base data Db and reference data Dr, which are indicated by the two-way arrows in the diagram.

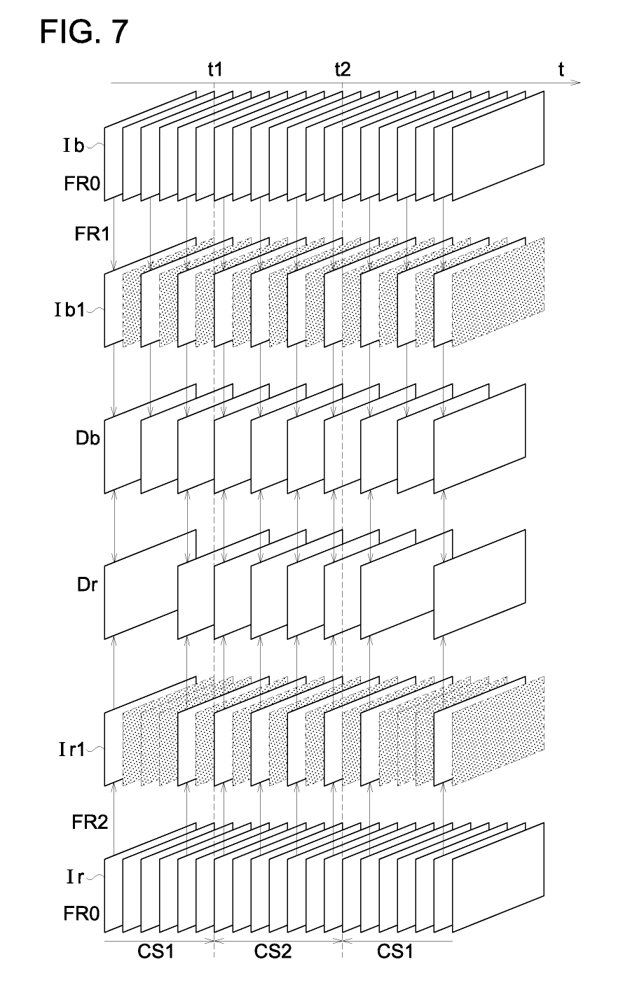

FIG. 7 is a schematic diagram showing the process of forming the base data Db and the reference data Dr in the case that the state changes from the normal state CS1 to the record-demanding state CS2, and changes again to the normal state CS1.

In FIG. 7, until time t1, the base data Db and reference data Dr have been recorded in the normal state CS1 of FIG. 4. At time t1, one of the four signals of the vehicle speed signal SS, the steering angle signal HS, the parallax change signal Pr, and the optical flow change signal Of has met the judging criterion for the record-demanding state CS2, and the normal state CS1 of FIG. 4 has been changed to the record-demanding state CS2 of FIG. 6, with the result that the reference data Dr is recorded at the same high density as the base data Db.

This state remains unchanged until time t2. During this time, the reference data Dr continues to be recorded at the same high density as the base data Db. Thus, if there is an traffic accident, the distance is calculated from the stereo image, based on the base data Db and the reference data Dr recorded at a high density, and the higher-precision analysis of the accident can be conducted.

AT time t2, all the aforementioned four signals have returned to the normal state CS1; accordingly, the record-demanding state CS2 of FIG. 6 has changed back to the normal state CS1 of FIG. 4, and the base data Db and the reference data Dr in the normal state CS1 start to be recorded.

As described above, the second frame rate FR2 for recording the reference data Dr is determined dynamically based on the four signals, which are the surroundings, consisting of the vehicle speed signal SS, the steering angle signal HS, the parallax change signal Pr, and the optical flow change signal Of and indicate the state of the own vehicle and its surrounding, and if a collision is likely to occur, the stereo images are recorded at a high density, whereby the higher-precision analysis of the accident will be conducted.

As described above, according to the first embodiment, the image captured by the base camera is subjected to thinning at the first frame rate, and the base data without being compressed or after being compressed at a low compression rate is generated and recorded. The image captured by the reference camera is subjected to thinning at the second frame rate which is the same as, or lower than, the first frame rate, and which is dynamically determined depending on the conditions of the own vehicle and its surroundings. Then the reference data without being compressed or after being compressed at a low compression rate is generated and recorded. This arrangement provides a less expensive device for acquiring a stereo image capable of recording a high-quality stereo image and obtaining high-precision distance information, without using an expensive storage medium or electronic circuit.

The second frame rate for recording the aforementioned reference data is determined dynamically based on the four signals, which are the vehicle speed signal, the steering angle signal, the parallax change signal, and the optical flow change signal and indicate the state of the own vehicle and its surroundings; thus a collision is likely to occur, the stereo image is recorded at a higher density, whereby a higher-precision analysis of the accident will be conducted.

Further, of the images of the frame not used to generate the first reference thinned-out frame, the images of the frame synchronized with the first frame rate are used to generate the second reference data; thus, the distance is calculated from the stereo image, and the high precision analysis of the accident can be conducted in return for a mall increase in the data amount although the precision is not good due to a higher compression rate.

In the first embodiment, if as the base camera 111 and reference camera 112, a camera capable of capturing an image not at a prescribed frame rate FR0 but at the first frame rate FR1 is employed, and the first frame rate FR1 is equal to a prescribed frame rate FR0, it is possible to omit at least the basic thin-out section 1911 of the base data generation section 191.

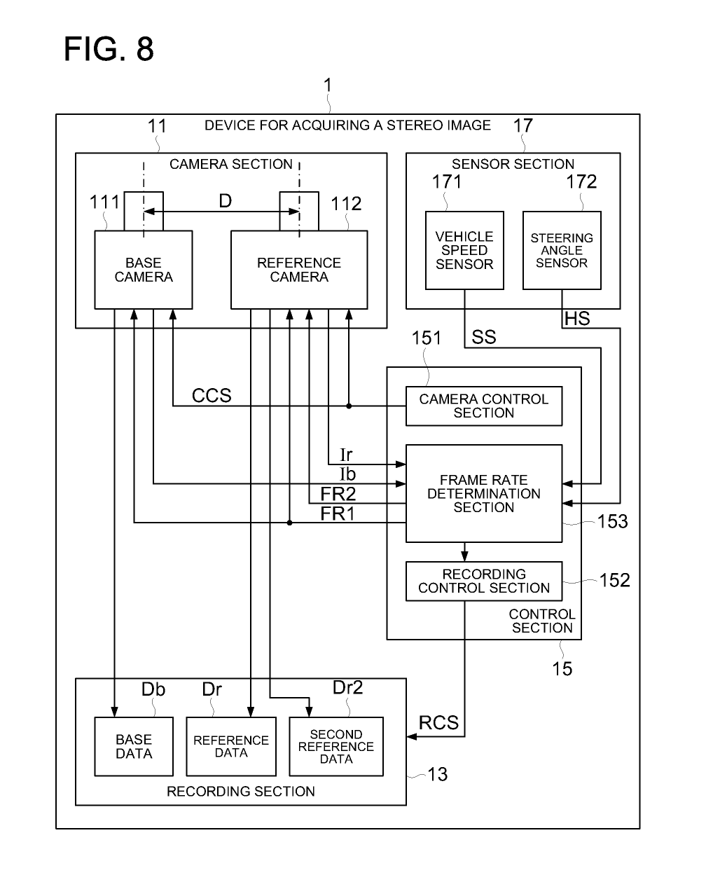

Referring to FIG. 8, the following describes the second embodiment of the device for acquiring a stereo image according to the present invention. FIG. 8 is a block diagram showing the structure of the second embodiment of a device for acquiring a stereo image.

In reference to FIG. 8, the data generation section 19 of the first embodiment is omitted in the second embodiment, and the function of the base data generation section 191 of the data generation section 19 is provided in the base camera 111, and the function of the reference data generation section 192 is provided in the reference camera 112.

The base camera 111 and the reference camera 112 of the camera section 11 are synchronized with the camera control signal CCS from the camera control section 151, and the base images Ib are outputted from the base camera 111, and the reference images Ir are outputted from the reference camera 112 at a prescribed frame rate FR0. The base images Ib and the reference images Ir are inputted into the frame rate determination section 153, and the first frame rate FR1 and the second frame rate FR2 are determined as shown in FIG. 2.

The determined first frame rate FR1 is inputted into the base camera 111 and the reference camera 112, and the second frame rate FR2 is inputted into the reference camera 112.

The base camera 111 performs thinning process on the base images Ib at the first frame rate FR1, and outputs the base images Ib as the base data Db to the recording section 13 without being compressed or after being compressed at a low compression rate.

The reference camera 112 performs thinning process on the reference images Ir at the second frame rate FR2, and outputs the reference images Ir as the reference data Dr to the recording section 13 without being compressed or after being compressed at a low compression rate. Further, of the images of the frame not used to generate the reference data Dr, the images of the frames synchronized with the first frame rate are compressed at a high compression rate by the reference camera 112 and are outputted as the second reference data Dr2 to the recording section 13. Other operations are the same as those of the first embodiment and will not be described to avoid duplication.

In the second embodiment in particular, the base data Db and the reference data Dr are uncompressed and the second reference data Dr2 is not generated. With this structure, it is not required to perform compression in the camera, and the data generation section 19 of the first embodiment can be omitted, thereby putting much load on the base camera 111 and the reference camera 112. This arrangement ensure a higher speed in the processing of the device for acquiring a stereo image 1, a simplified structure, and reduction of the manufacturing cost. The process of generating the base data Db and the reference data Dr in this arrangement is the same as that of FIG. 7.

Instead, the second embodiment can employ as the base camera 111 a camera capable of capturing an image not at a prescribed frame rate FR0 but at the first frame rate FR1, and as the reference camera 112 a variable-frame-rate camera capable of capturing not at a prescribed frame rate FR0 but at an image at the second frame rate FR2.

The following describes a third embodiment of the device for acquiring a stereo image according to the present invention. In the third embodiment, when the state of the own vehicle and its surroundings falls in the normal state CS1 of the first and second embodiments, the base data Db and the reference data Dr are not recorded in the recording section 13, and only when the state of the own vehicle and its surroundings falls in the record-demanding state CS2, the base data Db and reference data Dr are recorded in the recording section 13.

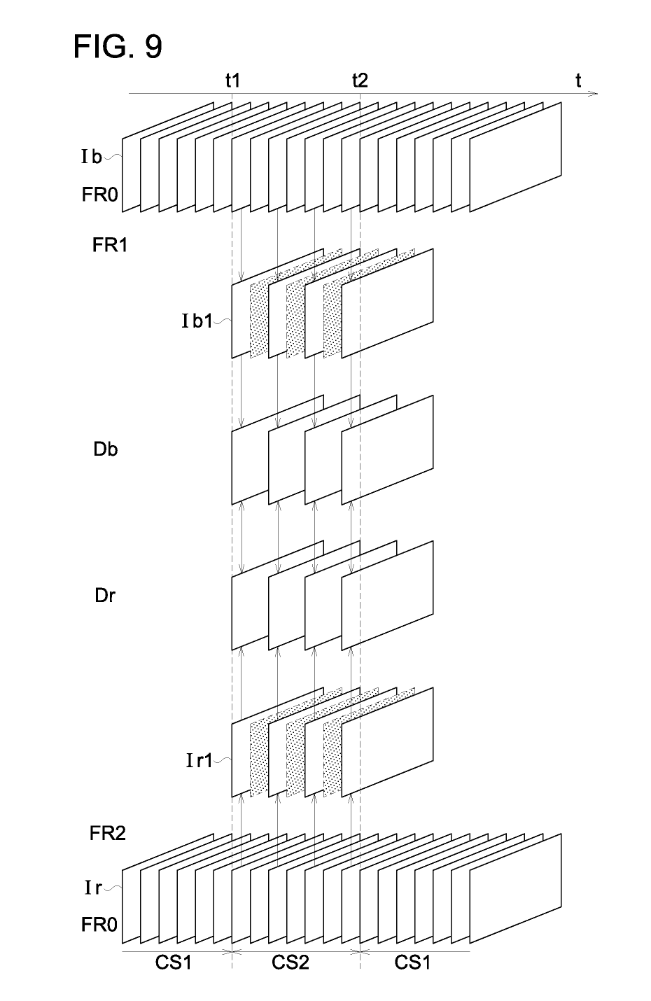

FIG. 9 shows the process of generating the base data Db and the reference data Dr. FIG. 9 is a schematic diagram showing the process of generating the base data Db and the reference data Dr in the third embodiment of the device for acquiring a stereo image of the present invention, and the schematic view shows the process of generating the base data Db and the reference data Dr in the case that the state changes from the normal state CS1 to the record-demanding state CS2 and changes again to the normal state CS1.

In FIG. 9, until time T1, the state is the aforementioned normal state CS1, and the base camera 111 captures the base images Ib at a prescribed frame rate FR0, but the base data Db is not recoded. Similarly, the reference camera 112 captures the reference images Ir at a prescribed frame rate FR0, but the reference data Dr is not recorded.

Synchronously with time t1, any one of the four signals consisting of vehicle speed signal SS, steering angle signal HS, parallax change signal Pr and optical flow change signal Of has met the decision condition under the record-demanding state CS2. Accordingly, the normal state CS1 changes over to the record-demanding state CS2. In this state, the base images Ib are thinned out at the first frame rate FR1 and the basic thinned-out image Ib1 is generated. This is recorded as base data Db. Similarly, the reference images Ir are thinned out at the second frame rate FR2 and reference thinned-out images Ir1 are generated. This is recorded as reference data Dr.

In FIG. 9, similarly to the case of FIG. 6, the first frame rate FR1 is equal to the second frame rate FR2, and the reference data Dr is recorded at the same high density as the base data Db.

The record-demanding state CS2 continues until the time t2. During that period, the reference data Dr is kept to be recorded at the same high density as the base data Db. Thus, if an accident happens, since the distance is calculated from a stereo image based on the base data Db and reference data Dr recorded at high density, whereby the higher-precision analysis of an accident can be conducted.

At time t2, all the aforementioned four signals return to the normal state CS1. Accordingly, the record-demanding state CS2 changes back to the normal state CS1, and images are taken by the base camera 111 and reference camera 112, but neither the base data Db nor reference data Dr is recorded.

As described above, the second frame rate FR2 for recording the reference data Dr is determined dynamically based on the four signals, which are the vehicle speed signal SS, the steering angle signal HS, the parallax change signal Pr, and optical flow change signal Of and indicates state of the own vehicle and its surroundings. Only when a collision is likely to occur, the stereo images are recorded at a high density, whereby a higher-precision analysis of an accident can be conducted. At the same time, if there is no danger, data is not recorded, with the result that the recording time gets longer and the capacity of such a recording medium such as a hard disk and semiconductor memory can be reduced, whereby the apparatuses are downsized and the manufacturing cost is reduced.

As described above, according to the third embodiment, only when a collision is likely to occur, the stereo images are recorded at a high density, based on the four signals, which are the vehicle speed signal SS, the steering angle signal HS, the parallax change signal Pr, and the optical flow change signal Of, and indicates the state of the own vehicle and the surroundings. This arrangement provides higher-precision analysis of an accident. If there is no danger, data is not recorded. This prolongs the recording time and reduces the capacity of the recording medium such as a hard disk and semiconductor memory, with the result that a downsized apparatus and reduced manufacturing cost are ensured.

In the third embodiment, if the cameras capable of capturing an image at the first frame rate FR1, not at a prescribed frame rate FRO are used as a base camera 111 and reference camera 112, or if the first frame rate FR1 is equal to a prescribed frame rate FR0, it is possible to omit the base data generation section 191.

As described above, according to the present invention, the base data is generated at the first frame rate from the image captured by a base camera, and is recorded. The reference data is generated from the image captured by the reference camera and is recorded at the second frame rate which is the same as or lower than the first frame rate and which is dynamically determined depending on the conditions of the own vehicle and its surroundings. This arrangement provides a less expensive device for acquiring stereo images which is capable of recording high-quality stereo images and of obtaining high-precision distance information, without the need of using an expensive storage medium or electronic circuit.

The details of the structures constituting the device for acquiring a stereo image of the present invention can be modified without departing from the spirit of the present invention.

### DESCRIPTION OF THE NUMERALS

1 Device for acquiring a stereo image

11 Camera section

111 Base camera

112 Reference camera

13 Recording section

15 Control section

151 Camera control section

152 Recording control section

153 Frame rate determination section

1531 First frame rate determination section

1532 Second frame rate determination section

1533 Parallax change calculating section

1534 Optical flow change calculating section

17 Sensor section

171 Vehicle speed sensor

172 Steering angle sensor

19 Data generation section

191 Base data generation section

1911 Basic thin-out section

1912 Low compression rate compressing section

192 Reference data generation section

1921 Reference thin-out section

1922 Low compression rate compressing section

1923 High compression rate compressing section

CCS Camera control signal

CS1 Normal state

CS2 Record-demanding state

D: Base line length

Db: Base data

Dr: Reference data

Dr2: Second reference data

FR0: Prescribed frame rate

FR1: First frame rate

FR2: Second frame rate

HS: Steering angle signal

Ib: Base image

Ib1: Base thinned-out image

Ir: Reference image

Ir1: First reference thinned-out image

Ir2: Second reference thinned-out image

Of: Optical flow change signal

Pr: Parallax change signal

SS: Vehicle speed signal

1. A device for acquiring a stereo image which is configured to be mounted on a vehicle to acquire stereo images, each made up of a base image and a reference image, of surroundings of the vehicle, the device comprising:
a camera section having at least two cameras including a base camera for taking the base images of the stereo images and a reference camera for taking the reference images of the stereo images;
a frame rate determination section configured to determine a first frame rate and a second frame rate lower than the first frame rate;
a base data generation section to generate base data, from the base images taken by the base camera, on the basis of the first frame rate determined by the frame rate determination section; and
a reference data generation section configured to generate reference data, from the reference images taken by the reference camera, on the basis of the second frame rate; and
a recording section configured to record as record data the base data generated by the base data generation section and the reference data generated by the reference data generation section,
wherein the frame rate determination section dynamically determines the second frame rate, depending on conditions and surroundings of the vehicle when the camera section takes the base images and the reference images.

2. The device of claim 1, wherein the frame rate determination section dynamically determines the second frame rate on the basis of any one of or a combination of a plurality of the following conditions:
(1) a speed of the vehicle;
(2) an operation condition of a steering wheel of the vehicle;
(3) an amount of a change in an optical flow for at least one of the cameras; and
(4) an amount of a temporal change in a parallax between the base camera and the reference camera.

3. The device claim 1, wherein
the reference data generation section generates the reference data, in uncompressed form or after performing compression with a first compression rate, on the basis of the second frame rate, and the reference data generation section generates second reference data compressed with a second compression rate higher than the first compression rate, from an image which is of the reference image and is synchronized in the first frame rate and from which the reference data was not generated; and
the recording section records the base data, the reference data, and the second reference data as the record data.

4. A device for acquiring a stereo image configured to be mounted on a vehicle, the device comprising:
a camera section, the camera section including:
a base camera configured to take base images of stereo images; and
a reference camera configured to take reference images of stereo images;
a frame rate determination section, the frame rate determination section including:
a first frame rate determination section configured to determine a first frame rate used to record the base images as record data; and
a second frame rate determination section configured to determine a second frame rate, based on the first frame rate, used to record the reference images as record data; and
a recording section configured to record as the record data the base data and the reference data at a first frame rate and the second frame rate, respectively.

5. The device of claim 4, wherein the second frame rate determination section dynamically determines the second frame rate, depending on conditions and surroundings of the vehicle when the camera section takes the base images and the reference images.

6. The device of claim 4, wherein the second frame rate determination section determines the second frame rate to be lower than the first frame rate.

7. The device of claim 4, wherein the frame rate determination section dynamically determines the second frame rate on the basis of any one of or a combination of a plurality of the following conditions:
(1) a speed of the vehicle;
(2) an operation condition of a steering wheel of the vehicle;
(3) an amount of a change in an optical flow for at least one of the cameras; and
(4) an amount of a temporal change in a parallax between the base camera and the reference camera.

8. The device of claim 4, wherein
the reference data generation section generates the reference data, in uncompressed form or after performing compression with a first compression rate, on the basis of the second frame rate, and the reference data generation section generates second reference data compressed with a second compression rate higher than the first compression rate, from an image which is of the reference image and is synchronized in the first frame rate and from which the reference data was not generated; and
the recording section records the base data, the reference data, and the second reference data as the record data.
